(19) United States
(12) Patent Application Publication
(10) Pub. No.: US 2006/0213122 A1
(43) Pub. Date: Sep. 28, 2006

(54) Plant cultivation container without using a snake wood

(76) Inventor: Chao-An Chiu, Tainan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/086,700

(22) Filed: Mar. 22, 2005

(51) Int. Cl. A01G 9/02

(52) U.S. Cl. 47/65.7

(57) ABSTRACT

A plant cultivation container includes a waste tire rubber, and a saturated resin mixed with the waste tire rubber. Thus, the waste tire rubber has a plurality of concave and convex surfaces arranged in a staggered manner and a plurality of gaps located between the concave and convex surfaces so that the plant can climb along the waste tire rubber, thereby facilitating cultivation of the plant. In addition, the plant cultivation container reuses the waste tire rubber to provide a recycling effect, thereby preventing the waste tire rubber from causing an environmental pollution so as to protect the ambient environment.

### BACKGROUND OF THE INVENTION

1. Field of the Invention

The present invention relates to a plant cultivation container, and more particularly to a plant cultivation container without using a snake wood.

2. Description of the Related Art

A conventional plant cultivation container is made of a snake wood having different shapes, such as a trunk shape, so that a plant can climb along the snake wood, thereby facilitating cultivation of the plant. However, the snake wood is a natural material, so that the conventional plant cultivation container made of a snake wood easily consumes the natural resource.

### SUMMARY OF THE INVENTION

In accordance with the present invention, there is provided a plant cultivation container, comprising a waste tire rubber; and a saturated resin mixed with the waste tire rubber.

The primary objective of the present invention is to provide a plant cultivation container without using a snake wood.

Another objective of the present invention is to provide a plant cultivation container, wherein the waste tire rubber has a plurality of concave and convex surfaces arranged in a staggered manner and a plurality of gaps located between the concave and convex surfaces so that the plant can climb along the waste tire rubber, thereby facilitating cultivation of the plant.

A further objective of the present invention is to provide a plant cultivation container, wherein the waste tire rubber has a plurality of gaps located between the concave and convex surfaces, so that the waste tire rubber is gas permeable, thereby enhancing the ventilating effect of the plant cultivation container.

A further objective of the present invention is to provide a plant cultivation container, wherein the waste tire rubber has different shapes, thereby enhancing the aesthetic quality of the plant cultivation container.

A further objective of the present invention is to provide a plant cultivation container, wherein the plant cultivation container reuses the waste tire rubber to provide a recycling effect, thereby preventing the waste tire rubber from causing an environmental pollution so as to protect the ambient environment.

A further objective of the present invention is to provide a plant cultivation container, wherein the waste tire rubber has a mimic snake wood shape to replace the snake wood so as to protect the natural resource.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for making a plant cultivation container in accordance with the preferred embodiment of the present invention;

FIG. 2 is a perspective view of a waste tire rubber of a plant cultivation container in accordance with the preferred embodiment of the present invention;

FIG. 3 is a perspective view of a plant cultivation container in accordance with the preferred embodiment of the present invention;

FIG. 4 is a perspective view of a plant cultivation container in accordance with another embodiment of the present invention;

FIG. 5 is a perspective view of a plant cultivation container in accordance with another embodiment of the present invention;

FIG. 6 is a perspective view of a plant cultivation container in accordance with another embodiment of the present invention;

FIG. 7 is a perspective view of a plant cultivation container for a plant in accordance with the preferred embodiment of the present invention;

FIG. 8 is a perspective view of a plant cultivation container for a plant in accordance with another embodiment of the present invention; and

FIG. 9 is a perspective view of a plant cultivation container for a plant in accordance with another embodiment of the present invention.

### DETAILED DESCRIPTION OF THE INVENTION

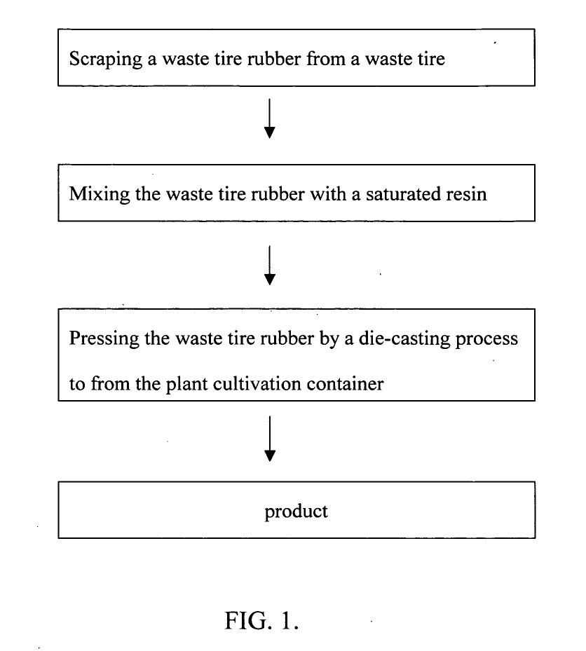

Referring to the drawings and initially to FIGS. 1-6, a plant cultivation container 1 in accordance with the preferred embodiment of the present invention comprises a waste tire rubber 11, and a saturated resin mixed with the waste tire rubber 11.

The waste tire rubber 11 has a mimic snake wood shape and includes a plurality of pieces 111 and a plurality of filaments 112 combined with the pieces 111. The pieces 111 and the filaments 112 are pressed by a die-casting process to form the waste tire rubber 11. The pieces 111 and the filaments 112 of the waste tire rubber 111 are mixed together and arranged in a staggered manner.

The saturated resin is preferably made of PU (polyurethane). The saturated resin and the waste tire rubber 11 are pressed by a die-casting process to form the plant cultivation container 1.

As shown FIG. 1, a method for making a plant cultivation container 1 in accordance with the preferred embodiment of the present invention comprises the following steps:

scraping a waste tire rubber 11 from a waste tire;

mixing the waste tire rubber 11 with a saturated resin; and

pressing the waste tire rubber 11 and the saturated resin by a die-casting process to form the plant cultivation container 1;

forming the product of the plant cultivation container 1.

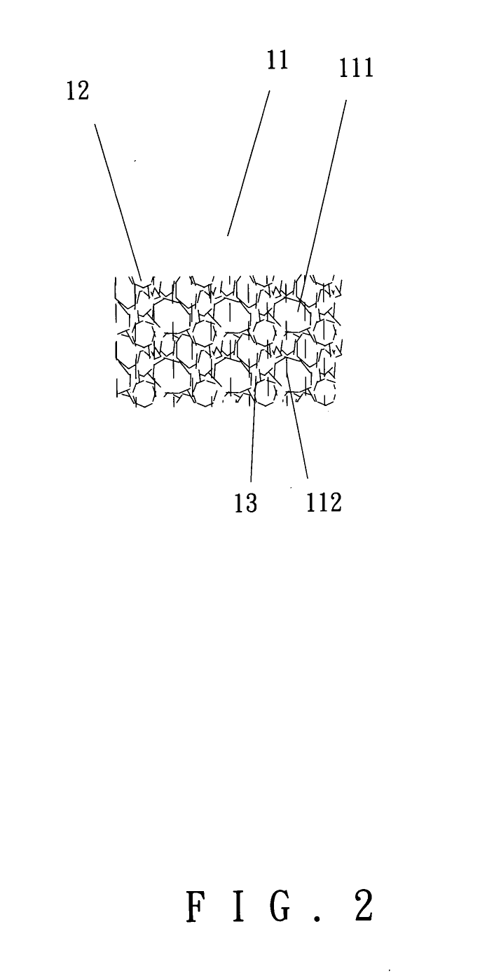

As shown FIG. 2, the waste tire rubber 11 has a surface and an inside formed with a plurality of concave and convex surfaces 12 arranged in a staggered manner and a plurality of gaps 13 located between the concave and convex surfaces 12.

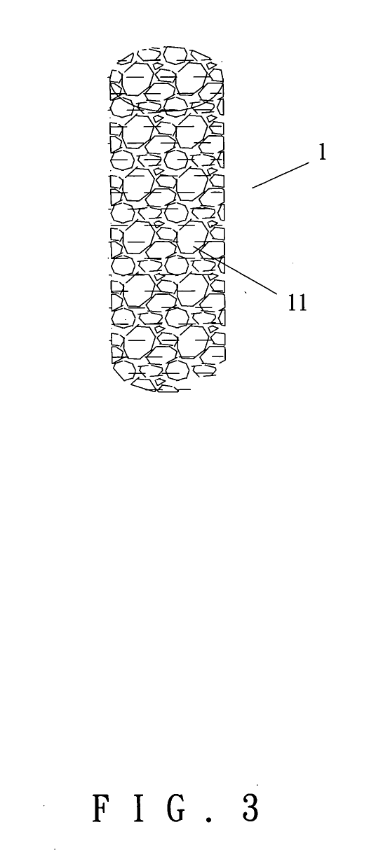

As shown FIG. 3, the waste tire rubber 11 of the plant cultivation container 1 has a column shape.

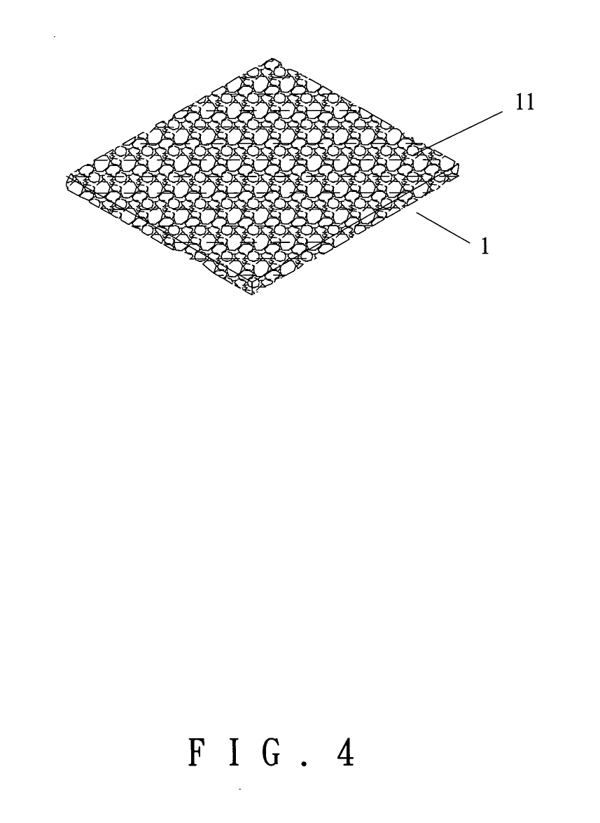

As shown FIG. 4, the waste tire rubber 11 of the plant cultivation container 1 has a sheet shape.

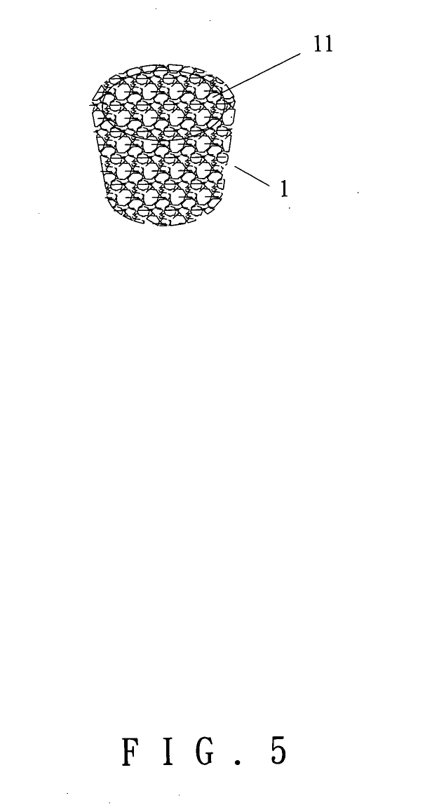

As shown FIG. 5, the waste tire rubber 11 of the plant cultivation container 1 has a basin shape.

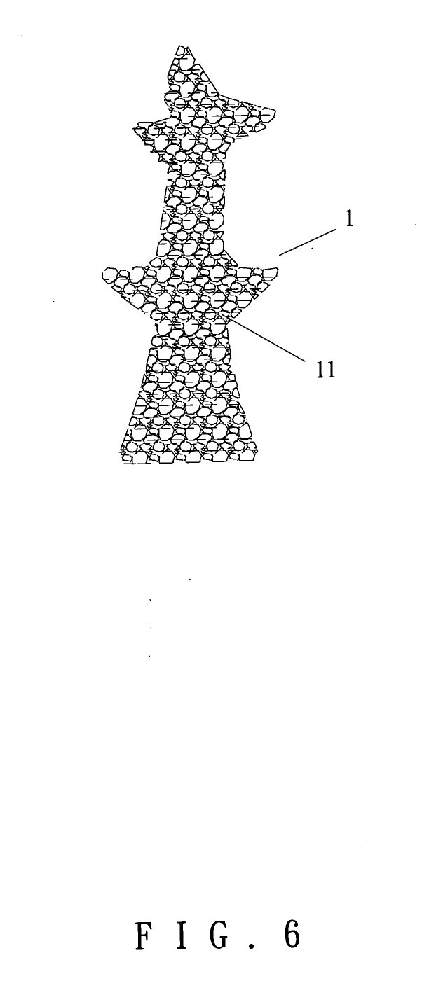

As shown FIG. 6, the waste tire rubber 11 of the plant cultivation container 1 has a trunk shape.

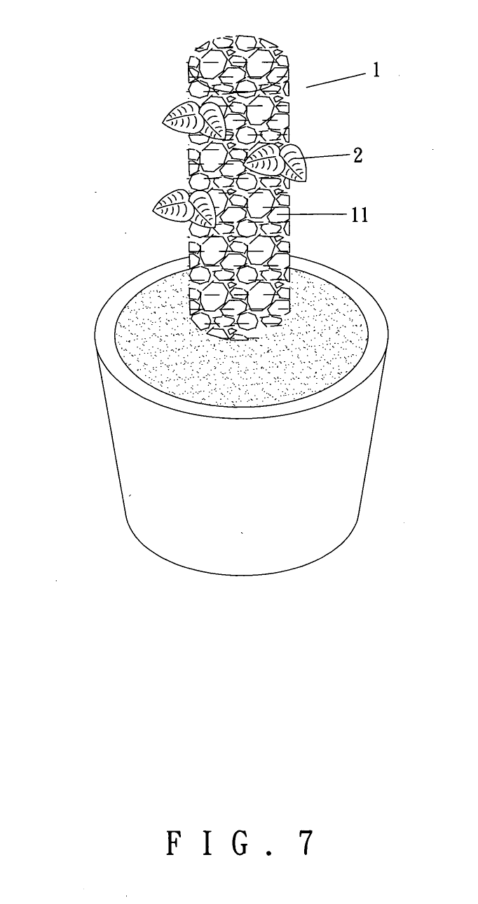

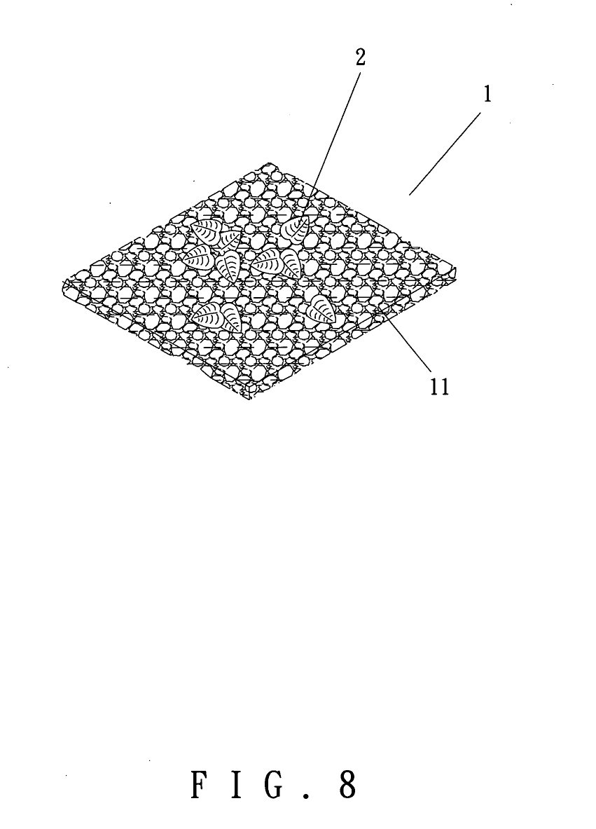

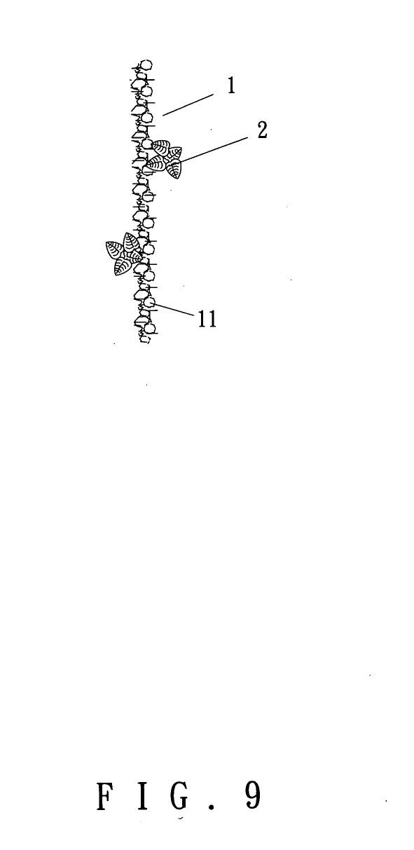

As shown FIGS. 7-9, the waste tire rubber 11 of the plant cultivation container 1 is used to cultivate a plant 2.

Accordingly, the waste tire rubber 11 has a plurality of concave and convex surfaces 12 arranged in a staggered manner and a plurality of gaps 13 located between the concave and convex surfaces 12 so that the plant 2 can climb along the waste tire rubber 11, thereby facilitating cultivation of the plant 2. In addition, the waste tire rubber 11 has a plurality of gaps 13 located between the concave and convex surfaces 12, so that the waste tire rubber 11 is gas permeable, thereby enhancing the ventilating effect of the plant cultivation container 1. Further, the waste tire rubber 11 has different shapes, thereby enhancing the aesthetic quality of the plant cultivation container 1. Further, the plant cultivation container 1 reuses the waste tire rubber 11 to provide a recycling effect, thereby preventing the waste tire rubber 11 from causing an environmental pollution so as to protect the ambient environment. Further, the waste tire rubber 11 has a mimic snake wood shape to replace the snake wood so as to protect the natural resource.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A plant cultivation container, comprising:
a waste tire rubber; and
a saturated resin mixed with the waste tire rubber.

2. The plant cultivation container in accordance with claim 1, wherein the waste tire rubber includes a plurality of pieces and a plurality of filaments combined with the pieces.

3. The plant cultivation container in accordance with claim 2, wherein the pieces and the filaments are pressed by a die-casting process to form the waste tire rubber.

4. The plant cultivation container in accordance with claim 2, wherein the pieces and the filaments of the waste tire rubber are mixed together and arranged in a staggered manner.

5. The plant cultivation container in accordance with claim 1, wherein the waste tire rubber has a mimic snake wood shape.

6. The plant cultivation container in accordance with claim 1, wherein the saturated resin is made of PU (polyurethane).

7. The plant cultivation container in accordance with claim 1, wherein the saturated resin and the waste tire rubber are pressed by a die-casting process to form the plant cultivation container.

8. The plant cultivation container in accordance with claim 1, wherein the waste tire rubber has a surface and an inside formed with a plurality of concave and convex surfaces arranged in a staggered manner and a plurality of gaps located between the concave and convex surfaces.

9. The plant cultivation container in accordance with claim 1, wherein the waste tire rubber has a column shape.

10. The plant cultivation container in accordance with claim 1, wherein the waste tire rubber has a sheet shape.

11. The plant cultivation container in accordance with claim 1, wherein the waste tire rubber has a basin shape.

12. The plant cultivation container in accordance with claim 1, wherein the waste tire rubber has a trunk shape.

13. The plant cultivation container in accordance with claim 1, wherein the waste tire rubber has different shapes.

14. A method for making a plant cultivation container, comprising:
scraping a waste tire rubber from a waste tire;
mixing the waste tire rubber with a saturated resin; and
pressing the waste tire rubber and the saturated resin by a die-casting process to form the plant cultivation container.
